(19) United States
(12) Patent Application Publication
(10) Pub. No.: US 2011/0126687 A1
(43) Pub. Date: Jun. 2, 2011

(54) POWER TOOL, ESPECIALLY HAND-HELD POWER TOOL

(75) Inventors: Hans Kaiser, Leuzigen (CH); Thilo Koeder, Gerlingen (DE); Joachim Platzer, Remseck-Hochbeerg (DE); Ulli Hoffmann, Niefern-Oeschelbronn (DE); Jan Koegel, Mount Prospect, IL (US)

(73) Assignee: Robert Bosch GMBH, Stuttgart (DE)

(21) Appl. No.: 12/992,753

(22) PCT Filed: Mar. 16, 2009
(86) PCT No.: PCT/EP2009/053045

§ 371 Date: Feb. 16, 2011

(30) Foreign Application Priority Data
May 14, 2008 (DE) 10 2008 001 769.8

(51) Int. Cl. B27B 19/00

(52) U.S. Cl. 83/746

(57) ABSTRACT

The invention relates to a power tool (1), which is designed as a jigsaw (2) and which comprises a rear support (2) for the saw blade (8) at a right angle to the rotational axis (22) of the saw blade (8). Said support (20) is designed as an element that is carried along by the saw blade in the rotational direction.

The invention relates to a power tool, especially a hand-held power tool according to the generic term of claim 1.

### STATE OF THE ART

Power tools of the previously mentioned type are known from EP 1 598 136 B1, namely in the configuration as a jigsaw, at which the saw blade is driven in a manner allowing stroke movement and which works in normal operation at a drive that is exclusively allowing stroke movement. If the drive in a manner allowing stroke movement is overlapped by pivoting movement around a pivot axis that lies transversely to the saw blade plane, the jigsaw works in the pendulum stroke mode. A further operating mode is given, if the jigsaw is operated as so-called scrolling jigsaw. Then an ability to rotate around a rotational axis that runs in its longitudinal direction is given in addition to the stroke movement of the saw blade, so that the corresponding working direction can be basically adjusted by rotating the saw blade.

The saw blade is impinged in all operating modes over a support arrangement on the back side, which is defined concentrically and rotatable to the saw blade or to the lifting rod of the saw blade and which is a support element impinging the saw blade back and provides a support roller. The support roller is supported at an arm, which runs in longitudinal direction of the rotational axis and which provides a low pivoting mobility in the direction of the saw blade plane.

Just as in the pendulum stroke mode a stroke mobility of the saw blade towards the support arrangement and the lifting rod guide on the side of the housing that is carrying it is also given in the scrolling mode. This stroke mobility in the pendulum stroke mode is overlapped by the common ability to pivot of the lifting rod guide with the support arrangement around the pivot axis that lies transversely to the saw blade plane, while a common ability to pivot of the lifting rod of the saw blade and the support arrangement for the saw blade is provided in the scrolling mode. This requires an alignment of the support arrangement towards the saw blade that is practically the same in the rotating position independent of the corresponding working conditions, thereby barely allows a variation of the supporting circumstances with regard to different working conditions and also causes a relatively elaborate construction.

### DISCLOSURE OF THE INVENTION

The invention is based on the task to achieve improved conditions for the creation of different supporting circumstances at least without further complicating the construction.

According to claim 1 this is thereby achieved, in that the support arrangement rotates with the saw blade while being dragged along it. Therefore an arrangement that is independent in the position of its rotational axis towards the lifting rod and if necessary also towards the lifting rod guiding on the side of the housing is possible for the support arrangement, without having to waive a common drive, for example a rotational drive that encroaches at the lifting rod, regarding the ability to rotate and due to the ability to rotate towards each other. But a forced coupling regarding the ability to rotate, in particular the ability to rotate around a common axis, is avoided. Therefore the possibility is opened, to realize corresponding desired working conditions on the one hand by the movement game, which brings along a dragged entrainment of the support arrangement by the saw blade, and on the other hand by the selected position of the rotational axis to each other as well as also by the configuration of the support contours.

According to the invention it proves to be useful to provide a guide along a guide surface that encroaches partially to the saw blade for the support arrangement, whose pole can preferably be located adjacent to the rotational axis of the saw blade, if necessary also concentrically to it, whereby the guide surface can be realized in its course also with different distances to its pole, in order to influence the supporting conditions also by this means.

Expediently the guide surface is construed as link guide, so that the support arrangement usefully provides a support arm in the connection of the guide surface to the saw blade back and is supported over a support element against the saw blade back, which is in particular construed as support roller.

The support roller is advantageously vaulted at the circumferences, expediently in such a way, that it provides a rounding radius, whose size corresponds with the distance of the rotational axis of the saw blade to the saw blade back. In particular running towards the rims a stronger curve can be provided. An arrangement of the support element, if necessary also in the form of a not rotatable support roller, which is fixed in its position towards the support arrangement, is also within the scope of the invention, whereby the support element can provide a correspondingly vaulted support contour, or can also be provided with a gutter-shaped slot for the saw blade back.

For the support arm a configuration as support yoke proves to be expedient, which is held in the guide link by corresponding link blocks, whereby tappets, rollers or such alike can be provided as link blocks.

Expediently the guide link is provided t a drive arm, which is driven in the pendulum stroke mode in sawing direction in a manner allowing stroke movement.

In particular it also lies within the scope of the invention to support the support arm in a ratable manner not only by the guide link, but—at a right axis position towards the guide link—also to the housing of the machine or the lifting rod guide on the side of the housing. Thereby the support and guide for the support arm can be stabilized.

With regard to a tilting free support of the saw blade back to the saw blade it also proves to be expedient if the saw blade back is rounded.

Further advantages and expedient configurations can be taken from the claims, the description of the figures and the drawings. It is shown in:

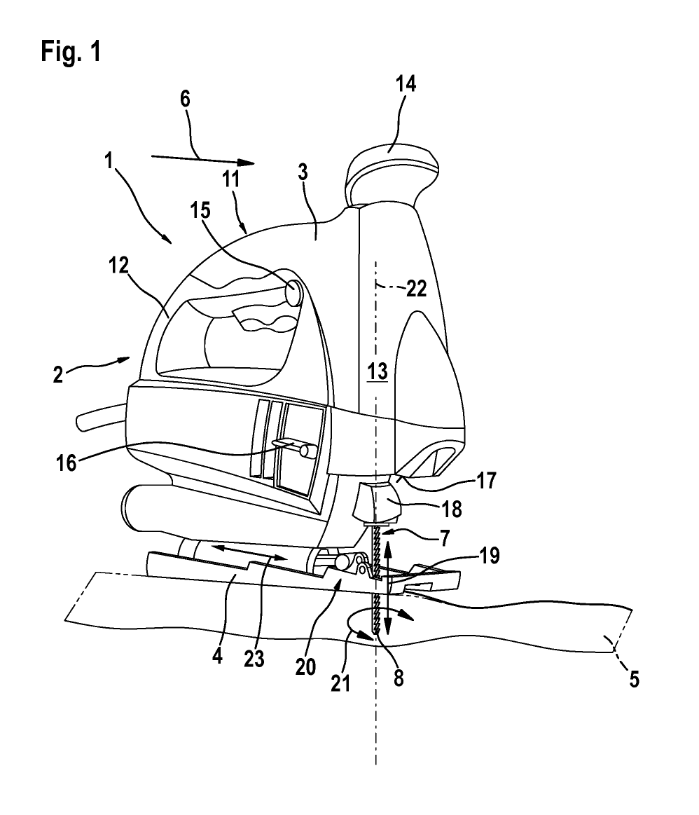

FIG. 1 a schematic illustration of an electrically driven jigsaw, which is construed as hand-held power tool and for which different operating modes are provided,

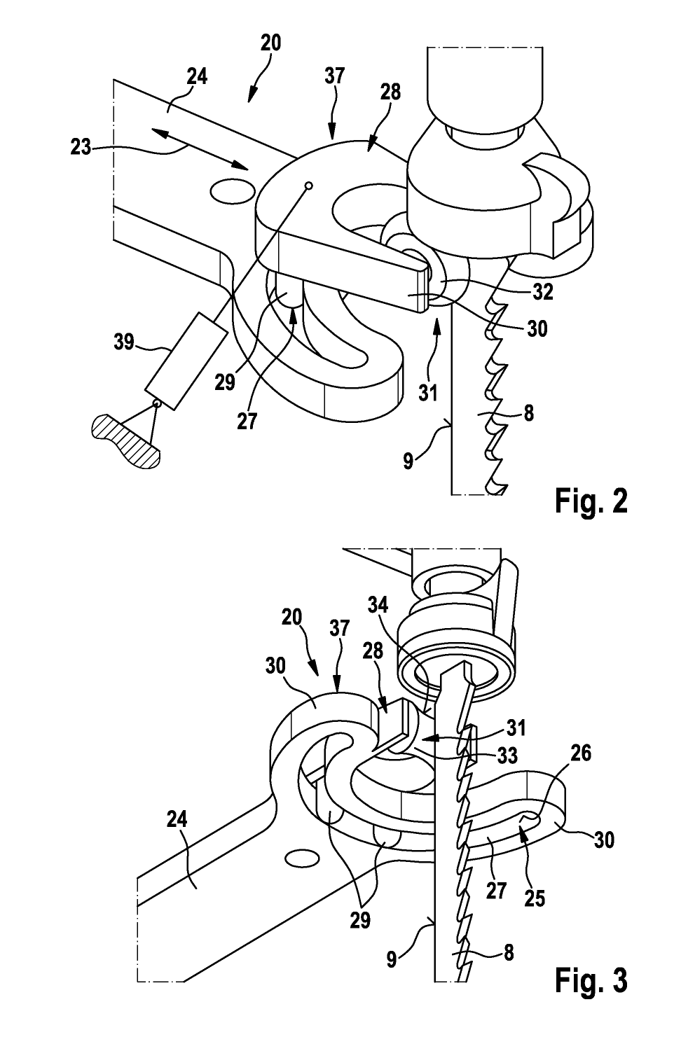

FIGS. 2 and 3 support arrangements for a saw blade of a jigsaw according to FIG. 1, whereby the support arrangement is dragged along during the rotation of the saw blade around its rotational axis,

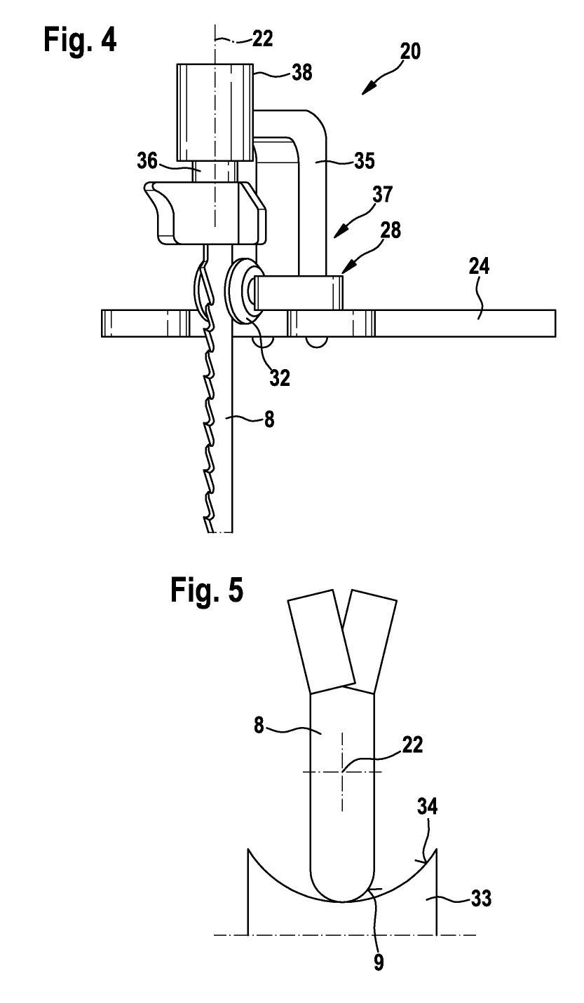

FIG. 4 a bridge-like support of the support arm of the support arrangement, and

FIG. 5 a further schematic illustration of the assignment of the saw blade to a support element of the support arrangement.

FIG. 1 illustrates a hand-held machine in the form of a jigsaw 2 as an example of a power tool 1, which provides a housing 3 and which is supported over a foot plate 4 on a work piece 5.

In the front area of the jigsaw 2 in working direction it provides a saw blade 8 as working tool 7. It encroaches upon the work piece 5 during the working mode, on which the jigsaw 2 is supported movably by the foot plate 4.

A handle 11 is provided at the housing 3 of the jigsaw 2 in vertical direction opposing the fixedly supported foot plate 4 that is running around a pivot axis in the direction of the longitudinal axis of the jigsaw 2, whose handle bow 12 runs towards a guiding knob 14. Encompassing the handle bow 12 a switch arrangement 15 is provided, over which the jigsaw 2 can be switched on and off. Different operating modes of the jigsaw 2 can be adjusted over the switch device 16 that is provided on the longitudinal side at the housing 3. The front wall area 13 of the housing 3 running towards the foot plate 4 is offset stepwise contrary to the working direction. The step 17 covers the power tool holder 18 for the driven work tool 7 that is established by the saw blade 8.

The saw blade 8 of the overall electrically driven power tool 1 provides a basic working position, in which it is only driven in a manner allowing stroke movement and which is oriented in the direction of the not shown longitudinal axis of the jigsaw 2, as it is illustrated by arrow 19.

The back 9 of the saw blade 8 is assigned to a support 20, which comprises a support arrangement 37. The support 20 is driven in a manner allowing stroke movement by a not shown drive in the direction of the plane of the saw blade 8 (arrow 23). This results in a further operating mode, namely the so-called pendulum stroke operation, in which the saw blade 8 can be pivoted around a not shown pivot axis that runs transversely to its blade plane and therefore also transversely to the sawing direction, overlapped to the stroke movement running in the longitudinal direction of the saw blade 8 (arrow 19). In a third operating mode, illustrated by arrow 21, the saw blade 8 can additionally be pivoted towards the stroke movement in the direction of its longitudinal axis around a rotational axis 22, which runs in its directions, and which is schematically indicated in FIG. 1. Thereby the saw blade 8 can be adjusted in angled working directions towards its straight working direction according to arrow 6 that corresponds with the basic working position, so that the jigsaw 2 can be used as so-called “scrolling jigsaw” and be also driven as semi-autonomous jigsaw 2 at a correspondingly controlled adjustment of the saw blade 8. Thereby the user who is holding the jigsaw 2 basically only takes over the feed that is roughly aligned towards the working direction, while an exact positioning that is oriented at a predefined course by adjusting the saw blade 8 on to a rotational position that corresponds with that predefined course.

FIGS. 2 and 3 illustrate the support 20 with its support arrangement 37. The support 20 comprises the drive arm 24, which is driven in pendulum stroke mode in the direction of the arrow 23 in a manner allowing stroke movement and which ends in a guiding surface 26 that corresponds with the drive arrangement 37 and that is construed as guide link 25.

The guiding surface 26 extends at least approximately semicircular around the rotational axis 22 of the saw blade 8. Link blocks 27, which are provided at a support arm 28, are guided in the guide link 25 of the guiding surface 26 that is provided at the drive arm 24. The link blocks 27 are established in the embodiment by two supporting tappets 29, which are distanced to each other in the direction of the extension of the guiding surface 26. The support arm 28 extends from the drive arm 24 against the saw blade 8 and ends against the saw blade 8 in yoke arms 30, in between which a guiding roller 32 lies as supporting element 31 in the configuration according to FIG. 2 and a cylinder-shaped guiding body 33 as supporting element 31 in the configuration according to FIG. 3. The guiding roller 32 provides a guiding channel at its circumferences, into which the saw blade 8 encroaches with its saw blade back 9 and which overlaps the flanks of the saw blade 8 in the back area.

The cylinder-shaped guiding body 33 that is arranged rotatable or fixed in position, provides a concavely vaulted supporting area 34 at the circumferences, as it is in particular illustrated in the schema illustration according to FIG. 5. The saw blade 8 abuts against supporting area 34 on the back side, namely only with its saw blade back 9. That is, as FIG. 5 shows, preferably construed rounded, so that only a linear contact results towards the guiding surface 34. A contour course proves to be useful for the guiding surface 34 in coordination with the corresponding supported saw blade 8, which corresponds approximately with a circular arc around the rotational axis 22 of the saw blade 8 with a radius, which—see FIG. 5—at least approximately corresponds in its angular point with the distance of the rotational axis 22 to the saw blade back 9.

the pivoting of the support arm 28 towards the drive arm 24 takes place in a dragged manner, namely dragged by the saw blade 8 at its rotational movement around the rotational axis 22, so that a construction is created, at which the rear support 20 for the saw blade 8 passively follows the rotation of the saw blade 8.

The illustrated usage of supporting tappets 29 is only exemplary and instead of such support tappets 29 also other form elements can be used, thus also characteristics at the support arm 28 that are adjusted in the radius or spring bolts, which additionally allow certain elasticity in the support of the saw blade 8 on the back.

As it is illustrated in FIG. 4—the support arm 28 can additionally also be supported in a rotatable manner within the scope of the invention outside of the area of the saw blade 8, for example by a bow 35, which is attached at the support arm 8 and which is mounted axially parallel to the rotational axis 22 of the saw blade 8, for example mounted in a rotatable manner on the lifting rod 36 over a case 38, or correspondingly in a different way, mounted at the not further shown lifting rod guide that is supported on the side of the housing, in particular also axially offset to the lifting rod 36 such a construction can contribute to a more stabile support and to an exact guide at a lower effort. Other than that the illustration according to FIG. 4 corresponds with the one of FIGS. 2 and 3 to which it is referred to.

1. Power tool, especially hand-held power tool, which is designed as a jigsaw comprising a saw blade, and which provides a rotational axis that runs in its longitudinal direction and which is driven in the direction of its rotational axis in a manner allowing stroke movement, and at a support arrangement is provided for the saw blade on the rear side that is rotating along with the saw blade wherein the support arrangement is rotating along with the saw blade along which it is dragged.

2. Power tool, especially hand-held power tool, which is designed as a jigsaw comprising a saw blade, and which provides a rotational axis that runs in its longitudinal direction and which is driven in the direction of its rotational axis in a manner allowing stroke movement, and at a support arrangement is provided for the saw blade on the rear side that is rotating along with the saw blade wherein the support arrangement and the saw blade are mounted rotating against each other.

3. The power tool according to claim 1 wherein the support arrangement and the saw blade provide at least approximately the same position of their rotational axes.

4. The power tool according to claim 1, wherein the support arrangement can be adjusted along a guide surface that is at least partially encroaching upon the saw blade.

5. The power tool according to claim 1, wherein the guide surface runs at least approximately concentrically to the rotational axis of the saw blade.

6. The power tool according to claim 1, wherein-the guide surface is construed as guide link.

7. The power tool according to claim 1, wherein the support arrangement provides a support arm, which carries a support element that is supported against the saw blade back.

8. The power tool according to claim 7 wherein the support element provides a concavely vaulted support area, whose radius corresponds at least in the central area at least approximately with the distance of the rotational axis of the saw blade from the saw blade back.

9. The power tool according to claim 8 wherein the support area is construed with a stronger becoming curve against.

10. The power tool according to claim 7, wherein the support element is created by a support roller.

11. The power tool according to claim 6, wherein the support arm is construed as support yoke, which is supported in the area of its bridge in the guide link.

12. The power tool according to claim 11 wherein the support arm is guided over link blocks that are arranged distanced along the guide link.

13. The power tool according to claim 12 wherein the link blocks are construed as tappets or rollers.

14. The power tool according to claim 1, wherein the guide link is provided at a drive arm, which is driven in the pendulum stroke mode in sawing direction in a manner allowing stroke movement.

15. The power tool according to claim 7, wherein the support arm can be rotated in particular over a bow as member of a support bridge around an axis that is at least approximately parallel to the rotational axis of the saw blade.

16. The power tool according to claim 1, wherein the saw blade provides a rounded saw blade back.
